(19) United States
(12) Patent Application Publication
(10) Pub. No.: US 2009/0265488 A1
(43) Pub. Date: Oct. 22, 2009

(54) DEVICE, SYSTEM, AND METHOD OF COMMUNICATING KEYBOARD-VIDEO-MOUSE (KVM) INFORMATION

(76) Inventor: Roi Birger, Haifa (IL)

Correspondence Address: EMPK & Shiloh, LLP;c/o Landon IP, Inc., 1700 Diagonal Road, Suite 450, Alexandria, VA, 22314, US

(21) Appl. No.: 12/104,468

(22) Filed: Apr. 17, 2008

(51) Int. Cl. G06F 13/12

(52) U.S. Cl. 710/64

(57) ABSTRACT

Device, system and method of communicating Keyboard-Video-Mouse (KVM) information. For example, a switch may include a plurality of KVM over Ethernet (KVM/Ethernet) modules to communicate KVM data over Ethernet communications; and a router to route the Ethernet communications between the plurality of KVM/Ethernet modules and one or more remote consoles. Other embodiments are described and claimed.

### FIELD

Some embodiments relate generally to the field of communicating Keyboard-Video-Mouse (KVM) information and, more particularly, to KVM switching.

### BACKGROUND

A Keyboard-Video-Mouse (KVM) switch may be implemented to allow one or more users, e.g., of one or more local console and/or one or more remote consoles, to control a plurality of servers using a keyboard, video monitor and mouse.

A KVM over Internet Protocol (KVM/IP) module may be used to communicate with a remote console over a communication network, e.g., over an Ethernet link. The KVM/IP module may receive a video input including video data corresponding to a video input from a server, and communicate to the remote console IP packets including the video data over the communication network. The KVM/IP module may also receive over the communication network IP packets including keyboard-mouse data from the remote console, and generate a keyboard-mouse output including keyboard-mouse data to be provided to the server.

### SUMMARY

Some embodiments include, for example, devices, systems, and methods of communicating Keyboard-Video-Mouse (KVM) information.

Some embodiments include a KVM switch including a plurality of KVM over Ethernet (KVM/Ethernet) modules to communicate KVM data over Ethernet communications; and a router to route the Ethernet communications between the plurality of KVM/Ethernet modules and one or more remote consoles.

In some embodiments, the router is to provide the plurality of KVM/Ethernet modules with Ethernet communications including keyboard-mouse data from the remote consoles, and to provide the remote consoles with Internet-Protocol (IP) packets including video data from the plurality of KVM/Ethernet modules.

In some embodiments, the plurality of KVM/Ethernet modules are to provide to the router Ethernet communications including video data based on a plurality of video inputs, respectively. The plurality of KVM/Ethernet modules may generate a plurality of respective keyboard-mouse outputs based on Ethernet communications including keyboard-mouse data.

In some embodiments, the plurality of KVM/Ethernet modules are assigned with a plurality of addresses, respectively, to communicate with the router via a local network. The router is capable of communicating with the remote consoles using an address different from the plurality of addresses.

In some embodiments, the router is capable of communicating with the remote consoles using an IP address.

In some embodiments, the KVM switch may include a local network switch to communicate between the plurality of KVM/Ethernet modules and the router via the local network.

In some embodiments, the KVM switch may include a port to connect the local network to a local network of at least one other KVM switch.

In some embodiments, the KVM switch may include one or more server ports to be connected to one or more servers, respectively; and a KVM switching matrix to switch KVM data between the servers and the plurality of KVM/Ethernet modules.

In some embodiments, the KVM switch may include at least one port to be connected to at least one local console, wherein the KVM switching matrix is to switch KVM data between the servers and the at least one local console.

In some embodiments, the KVM switch may include a processor capable of controlling switching of the KVM data by the KVM switching matrix, wherein the processor includes the router.

In some embodiments, the KVM/Ethernet modules may include KVM over IP (KVM/IP) modules, and the Ethernet communications may include IP packets.

In some embodiments, the KVM switch may include an integrated circuit including the router and the plurality of KVM/Ethernet modules.

Some embodiments include a system to communicate KVM information, the system may include one or more servers; and at least one KVM switch to switch KVM data between the one or more servers and one or more remote consoles. The KVM switch may include a plurality of KVM/Ethernet modules to communicate KVM data corresponding to the servers over Ethernet communications; and a router to route the Ethernet communications between the plurality of KVM/Ethernet modules and the remote consoles.

In some embodiments, the router is to provide the plurality of KVM/Ethernet modules with Ethernet communications including keyboard-mouse data from the remote consoles, and to provide the remote consoles with IP packets including video data from the plurality of KVM/Ethernet modules.

In some embodiments, the plurality of KVM/Ethernet modules are to provide to the router Ethernet communications including video data based on a plurality of video inputs, respectively; and the plurality of KVM/Ethernet modules are to generate a plurality of respective keyboard-mouse outputs based on Ethernet communications including keyboard-mouse data.

In some embodiments, the plurality of KVM/Ethernet modules are assigned with a plurality of addresses, respectively, to communicate with the router via a local network, and the router is capable of communicating with the remote consoles using an address different from the plurality of addresses.

In some embodiments, the KVM switch may include a port to connect the local network to a local network of at least one other KVM switch.

In some embodiments, the KVM switch may include one or more server ports to be connected to one or more servers, respectively; and a KVM switching matrix to switch KVM data between the servers and the plurality of KVM/Ethernet modules.

In some embodiments, the KVM switch may include a processor capable of controlling switching of the KVM data by the KVM switching matrix, and wherein the processor includes the router.

In some embodiments, the KVM/Ethernet modules may include KVM/IP modules, and the Ethernet communications may include IP packets.

In some embodiments, the KVM switch may include an integrated circuit including the router and the plurality of KVM/Ethernet modules.

Some embodiments include a method of communicating KVM information, the method may include receiving over a local network Ethernet communications from a plurality of KVM/Ethernet modules, wherein the Ethernet communications may include KVM data to be provided to one or more remote consoles; and routing IP packets corresponding to the Ethernet communications from the plurality of KVM/Ethernet modules to the remote consoles over a communication link.

In some embodiments, the method may include receiving from the remote consoles IP packets including KVM data; and providing Ethernet communications corresponding to the IP packets received from the remote consoles to the plurality of KVM/Ethernet modules over the local network.

In some embodiments, the plurality of KVM/Ethernet modules are assigned with a plurality of respective addresses, and the routing may include using an address different from the plurality of addresses.

In some embodiments, the method may include receiving over the local network Ethernet communications from one or more other KVM/Ethernet modules, which are connected by another local network; and routing IP packets corresponding to the Ethernet communications from the other KVM/Ethernet modules to the remote consoles over the communication link.

In some embodiments, the method may include switching KVM data received from one or more servers to the plurality of KVM/Ethernet modules; and switching KVM data corresponding to IP packets received from the remote consoles from the plurality of KVM/Ethernet modules to the servers.

In some embodiments, the method may include switching KVM data between the servers and at least one local console.

In some embodiments, the KVM/Ethernet modules may include KVM/IP modules, and the Ethernet communications may include IP packets.

Some embodiments may include, for example, a computer program product including a computer-useable medium including a computer-readable program, wherein the computer-readable program when executed on a computer causes the computer to perform methods in accordance with some embodiments of the invention.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system including a Keyboard-Video-Mouse (KVM) switch in accordance with some demonstrative embodiments; and

FIG. 2 is a schematic flow-chart illustration of a method of communicating KVM information in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Although portions of the discussion herein relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a blade server chassis, a server blade, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards, devices and/or networks operating in accordance with any suitable wired or wireless Ethernet standards, e.g., the existing IEEE 802.3 standards and/or future versions and/or derivatives and/or LTE of the above standards, devices and/or networks operating in accordance with any suitable Internet Protocol (IP), for example, IP version 4 (IPv4), IP version 6 (IPv6), and/or nay future versions and/or derivatives thereof, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS), Wi-Fi, Wi-Max, ZigBee, Global System for Mobile communication (GSM), 2G, 2.5G, 3G, 3.5G, or the like. Some embodiments may be used in various other devices, systems and/or networks.

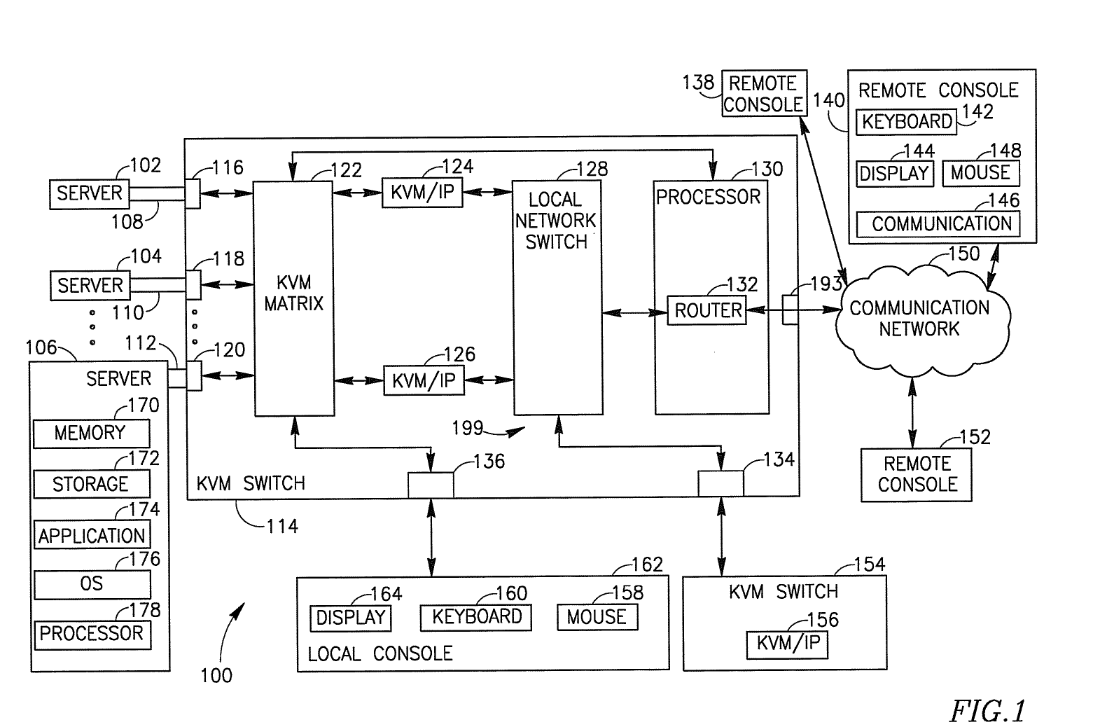

Reference is now made to FIG. 1, which schematically illustrates a block diagram of a system 100 in accordance with some demonstrative embodiments.

In some embodiments, system 100 may include one or more computers (also referred to as “servers”), e.g., including servers 102, 104 and 106. In one non-limiting example, system 100 may include sixteen servers. In another non-limiting example, system 100 may include thirty-two servers. In other embodiments, system 100 may include any suitable number of servers. System 100 may also include one or more console devices or systems, for example, one or more remote consoles 138, 140, and/or 152; and/or one or more local consoles, e.g., local console 162.

In some embodiments, servers 102, 104 and/or 106 may include, for example, a memory 170, storage 172, and a processor 178.

Processor 178 may include, for example, a central processing unit (CPU), a digital signal processor (DSP), a microprocessor, a host processor, a controller, a plurality of processors or controllers, a chip, a microchip, one or more circuits, circuitry, a logic unit, an integrated circuit (IC), an application-specific integrated circuit (ASIC), or any other suitable multi-purpose or specific processor or controller. Processor 178 may execute instructions and process data, for example, of an operating system (OS) 176 and/or one or more software applications 174.

Memory 170 may include, for example, a random access memory (RAM), a read only memory (ROM), a dynamic RAM (DRAM), a synchronous DRAM (SD-RAM), a flash memory, a volatile memory, a non-volatile memory, a cache memory, a buffer, a short term memory unit, a long term memory unit, or other suitable memory units or storage units. Memory 170 may be coupled to processor 178 by a system bus or other suitable interconnect.

Storage 172 may include, for example, a hard disk drive, a floppy disk drive, a compact disk (CD) drive, a CD-ROM drive, a digital versatile disk (DVD) drive, or other suitable removable or non-removable storage units. Memory 170 and/or storage 172 may, for example, store data processed by server 106.

In some embodiments, remote consoles 138, 140, and/or 152 may include a keyboard 142, a display 144, a mouse 148, and/or a communication unit 146. Local console 162 may include a keyboard 160, a display 164, and/or a mouse 158.

Keyboard 142 and/or keyboard 160 may include any suitable keyboard, keypad, touch-pad, and the like.

Display 144 and/or display 164 may include, for example, a cathode ray tube (CRT) monitor or display unit, a liquid crystal display (LCD) monitor or display unit, a screen, a monitor, or other suitable display.

Communication unit 146 may include, for example, a wired or wireless network interface card (NIC), a wired or wireless modem, a wired or wireless receiver and/or transmitter, a wired or wireless transmitter-receiver and/or transceiver, a radio frequency (RF) communication unit or transceiver, or other units able to transmit and/or receive signals, blocks, frames, transmission streams, packets, messages and/or data over a communication network 150. Communication unit 146 may optionally include or may optionally be associated with one or more antennas. Communication network 150 may include, for example, an Ethernet network, or any other suitable communication network.

In some embodiments, system 100 may include at least one KVM switch 114 capable of communicating KVM information between servers 102, 104, and/or 106 and consoles 138, 140, 152, and/or 162, e.g., as described in detail below. For example, KVM switch 114 may communicate video information, e.g., corresponding to application 174 and/or OS 176, from servers 102, 104, and/or 106, to consoles 138, 140, 152, and/or 162; and/or communicate from consoles 138, 140, 152, and/or 162 to servers 102, 104, and/or 106 keyboard and/or mouse information, e.g., to be provided to application 174 and/or OS 176. In one example, a user of remote console 140 may use keyboard 142 and/or mouse 148 to manipulate, control, and/or utilize application 174 and/or OS 176; and display 144 to display images generated by application 174 and/or OS 176.

In some embodiments, KVM switch 114 may include one or more server ports, e.g., ports 116, 118 and/or 120, to be connected to the one or more servers, e.g., servers 102, 140 and/or 106, respectively. Ports 116, 118 and 120 may include any suitable port type and/or configuration to be associated with servers 102, 104, and 106, respectively. Server 102 may be connected to port 116 via one or more cables 108; server 104 may be connected to port 118 via one or more cables 110; and/or server 106 may be connected to port 120 via one or more cables 112.

In one example, port 116, port 118 and/or port 120 may include a Universal Serial Bus (USB) port or a PS/2 port to communicate keyboard and/or mouse information with servers 102, 104 and/or 106, respectively; and a video port, e.g., a Video Graphics Array (VGA) port, to communicate video information with servers 102, 104 and/or 106, respectively.

In some embodiments, KVM switch 114 may include a plurality of KVM over Ethernet (KVM/Ethernet) modules to communicate KVM data over Ethernet communications. The KVM/Ethernet modules may include or may be implemented as part of any suitable, device, element, unit, or system on chip. In some no-limiting examples, one or more of the KVM/Ethernet modules may include a KVM over internet-protocol (KVM/IP) module to communicate KVM data over IP packets. In one non-limiting example, the plurality of KVM/Ethernet modules may include two KVM/IP modules 124 and 126. In other embodiments, the plurality of KVM/Ethernet modules may include any other suitable number of KVM/Ethernet and/or KVM/IP modules.

In some embodiments, KVM/IP modules 124 and 126 may receive, for example, video inputs including video data corresponding to video inputs from servers 102, 104, and/or 106, and generate IP packets including the video data; and receive IP packets including keyboard-mouse data from remote consoles 138, 140, and/or 152, and generate keyboard-mouse outputs including keyboard-mouse data to be provided to servers 102, 104 and/or 106, e.g., as described below.

In some embodiments, KVM switch 114 may include a router 132 to route the IP packets between KVM/IP modules 124 and 126 and remote consoles 138, 140 and/or 152, for example, via communication network 150, e.g., as described below. For example, KVM switch 114 may include a communication port 193 to be connected to network 150. Port 193 may include, for example, a fast Ethernet port, e.g., a 10/100 Mega-bits-per second (Mbps) port, or any other suitable port.

Router 132 may include any router, e.g., any suitable Ethernet router, capable of routing IP packets over communication network 150. In a non-limiting example, router 132 may be implemented by a processor 130, e.g., as described herein. In other examples, router 132 may be implemented in any other suitable manner, e.g., using any suitable hardware and/or software.

Although some non-limiting embodiments are described herein with reference to KVM/IP modules, e.g., KVM/IP modules assigned with IP addresses, capable of communicating IP packets, e.g., using the IP addresses, it will be appreciated that other embodiments may include any other suitable KVM/Ethernet modules, e.g., KVM/Ethernet modules assigned with Media-Access-Control (MAC) addresses, to communicate any other suitable of Ethernet communications, e.g., using the MAC addresses. In some embodiments, KVM/IP modules 124 and/or 126 may be replaced, for example, by KVM/Ethernet modules capable of generating Ethernet communications including KVM data. For example, the KVM/Ethernet modules may receive video inputs including video data corresponding to video inputs from servers 102, 104, and/or 106, and generate Ethernet communications including the video data; and receive Ethernet communications including keyboard-mouse data from remote consoles 138, 140, and/or 152, and generate keyboard-mouse outputs including keyboard-mouse data to be provided to servers 102, 104 and/or 106. According to this example, router 132 may be replaced by a suitable router to route to remote consoles 138, 140 and/or 152 IP packets corresponding to the Ethernet communications from the KVM/Ethernet modules; and/or to route to the KVM/Ethernet modules Ethernet communications corresponding to IP packets received from remote consoles 138, 140 and/or 152.

In some demonstrative embodiments, the plurality of KVM/IP modules of switch 128, e.g., KVM/IP modules 124 and 126, may communicate with router 132 via a local network 199, e.g., a local Ethernet network.

In some embodiments, local network 199 may be configured as a subnetwork (also referred to as “subnet”), for example, by assigning a plurality of addresses, e.g., IP addresses, to the plurality of KVM/IP modules, respectively. Router 132 may be assigned with an address, e.g., an IP address, different from the addresses of the KVM/IP modules, to communicate over communication network 150, e.g., with remote consoles 138, 140, and 152. For example, KVM/IP modules 124 and 126 may be assigned with addresses having an identical binary sequence, e.g., including one or more identical bytes. In one non-limiting example, KVM/IP module 124 may be assigned with a first address, e.g., 17.77.79.1, and KVM/IP module 126 may be assigned with a second address, e.g., 17.77.79.2, wherein the first three bytes of the first and second addresses are identical. In other embodiments, the local network between KVM/IP modules 124 and 126, and router 132 may be configured in any other suitabel manner. For example, in some embodiments switch 114 may include KVM/Ethernet modules assigned with any suitable addresses, e.g., MAC addresses, to communicate Ethernet communications over local network 199.

In some embodiments, KVM switch 114 may include a local network switch 128 to communicate between KVM/IP modules 124 and 126 and router 132 via local network 199.

In some embodiments, router 132 may receive via communication network 150 IP packets including keyboard-mouse data (“the keyboard-mouse IP packets”) from remote consoles 138, 140 and/or 152. Router may provide the received keyboard-mouse IP packets to KVM/IP modules 124 and 126 via local network 199. KVM/IP modules 124 and 126 may receive the keyboard-mouse IP packets, and generate respective keyboard-mouse outputs based on the keyboard-mouse IP packets. For example, remote consoles 138, 140 and/or 152 may direct the keyboard-mouse IP packets, which may include keyboard-mouse data intended for servers 102, 104, and/or 106, to the IP address of router 132; and router 132 may route the keyboard-mouse IP packets to KVM/IP modules 124 and 126, via local network 199.

In some embodiments, KVM/IP modules 124 and 126 may receive respective video inputs including video data received from servers 102, 104, and/or 106. KVM/IP modules 124 and 126 may generate IP packets (“the video IP packets”) including video data based on the video inputs. Router 132 may receive the video IP packets from KVM/IP modules 124 and 126, and may route the video IP packets to remote consoles 138, 140 and/or 152. For example, KVM/IP modules 124 and 126 may direct the video IP packets, which may be intended for remote consoles 138, 140 and/or 152, to router 132 via local network 199; and router 132 may route the video IP packets to remote consoles 138, 140, an/or 152 via communication network 150.

In some embodiments, KVM switch 114 may also include a port 134, for example, a fast Ethernet port, e.g., a 10/100 Mbps port, or any other suitable port, to connect between local network 199 of KVM switch 114 and at least one local network of at least one other KVM switch 154, respectively. For example, port 134 may connect at least one external KVM/IP module 156 of KVM switch 154 to router 132 via local network 199 of KVM switch 114; and/or connect KVM/IP modules 124 and/or 126 to a router (not shown) of KVM switch 154.

The connection between the local networks of KVM switches 114 and 154 may be used to enable a communication link redundancy, e.g., with respect to network 150 and/or one or more other networks. In one non-limiting example, router 132 may communicate with network 150 via a first link, e.g., an Asymmetric Digital Subscriber Line (ADSL), and the router of KVM switch 154 may communicate with a network, e.g., 150 or another communication network, via a second link, e.g., a Point-to-Point (PTP) link. Accordingly, the IP packets may be routed between KVM/IP modules 124, 126 and/or 156, and remote consoles 138, 140 and/or 152 using either the ADSL link of router 132 or the PTP link of the router of KVM switch 154.

In some embodiments, KVM switch 114 may include a KVM switching matrix 122 to switch KVM data between servers 102, 104, and/or 106, e.g., via ports 116, 118, and/or 120, respectively, and KVM/IP modules 124 and 126. For example, KVM switching matrix 122 may include a category 5 (CAT5) KVM matrix, or any other suitable KVM matrix. In one example, KVM switching matrix 122 may include a 2×16 switching matrix, e.g., to switch between sixteen servers and two KVM/IP modules. In another example, KVM switching matrix 122 may include a 2×32 switching matrix, e.g., to switch between thirty-two servers and two KVM/IP modules. In another example, KVM switching matrix 122 may include an M by N (M×N) switching matrix to switch between any suitable plurality of N servers and any suitable plurality of M KVM/IP modules.

In some embodiments, KVM switching matrix 122 may switch KVM data between servers 102, 104 and 106 and at least one local console 162. For example, KVM switch 114 may include at least one local console port, e.g., port 136, to be connected to at least one local console 162. Port 136 may include any suitable port type and/or configuration to be associated with local console 162. In one example, port 136 may include a USB port or a PS/2 port to communicate keyboard and/or mouse information with local console 162; and a video port, e.g., VGA port, a digital video port, e.g., High-Definition-Multimedia Interface (HDMI), Digital-Video-Interface (DVI), and/or Display-Port, or any other suitable port, to communicate video information with local console 162.

In some embodiments, processor 130 may be capable of controlling the switching of the KVM data by KVM switching matrix 122, e.g., using any suitable KVM matrix control application, scheme, algorithm and/or method.

In some non-limiting embodiments, KVM switch 114 may be implemented as an Integrated Circuit (IC) or a chip, e.g., including router 132 and KVM/IP modules 124 and 126.

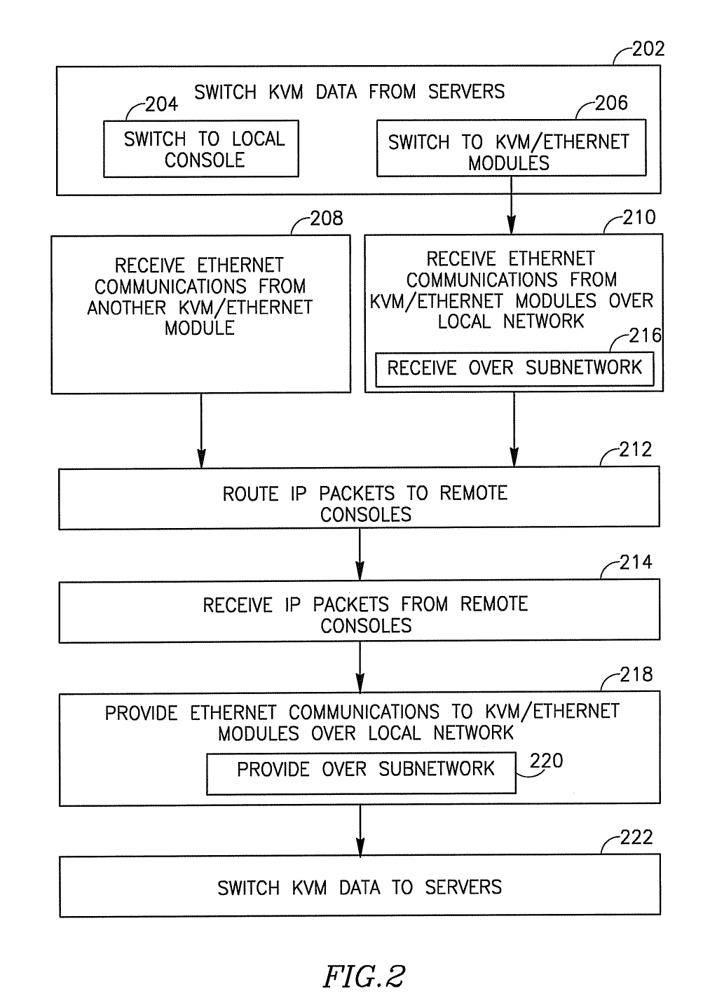

Reference is also made to FIG. 2, which schematically illustrates a method of communicating KVM information in accordance with some demonstrative embodiments. In some non-limiting embodiments one or more operations of the method of FIG. 2 may be performed by one or more elements of system 100 (FIG. 1), e.g., KVM switch 114 (FIG. 1), to communicate KVM information between one or more servers, e.g., servers 102 (FIG. 1), 104 (FIG. 1), and/or 106 (FIG. 1), and one or more consoles, e.g., consoles 138 (FIG. 1), 140 (FIG. 1), 152 (FIG. 1), and/or 162 (FIG. 1).

As indicated at block 202, the method may include switching KVM data received from one or more servers. Switching the KVM data may include, for example, switching the KVM data to a plurality of KVM/Ethernet modules, as indicated at block 206. Switching the KVM data may also include switching the KVM data to at least one local console, as indicated at block 204. For example, KVM switching matrix 122 (FIG. 2) may switch KVM data between servers 102 (FIG. 1), 104 (FIG. 1), and/or 106 (FIG. 1); and KVM/IP modules 124 (FIG. 1) and 126 (FIG. 1), and/or local console 162 (FIG. 1), e.g., as described above.

As indicated at block 210, the method may include receiving over a local network Ethernet communications, e.g., IP packets, from the plurality of KVM/Ethernet modules. The Ethernet communications received from the KVM/Ethernet modules may include video data to be provided to one or more remote consoles. For example, router 132 (FIG. 1) may receive IP packets from KVM/IP modules 124 (FIG. 1) and 126 (FIG. 1), e.g., as described above.

As indicated at block 212, the method may include routing IP packets corresponding to the Ethernet communications received from the plurality of KVM/Ethernet modules to the remote consoles over a communication link. For example, router 132 (FIG. 1) may route IP packets corresponding to the Ethernet communications to remote consoles 138 (FIG. 1), 140 (FIG. 1), and/or 152 (FIG. 1), via communication network 150 (FIG. 1), e.g., as described above.

As indicated at block 214, the method may include receiving from the remote consoles IP packets intended for the one or more servers. For example, router 132 (FIG. 1) may receive over network 150 (FIG. 1) IP packets, e.g., including keyboard-mouse data, from remote consoles 138 (FIG. 1), 140 (FIG. 1), and/or 152 (FIG. 1), e.g., as described above.

As indicated at block 218, the method may include providing Ethernet communications corresponding to the IP packets received from the remote consoles to the plurality of KVM/Ethernet modules over the local network. For example, router 132 (FIG. 1) may provide the IP packets received over network 150 (FIG. 1) to KVM/IP modules 124 (FIG. 1) and 126 (FIG. 1), e.g., as described above.

In some embodiments, the local network may include a subnetwork. For example, the plurality of KVM/Ethernet modules may be assigned with a plurality of respective addresses, and the routing may include using an address different from the plurality of addresses. For example, receiving the Ethernet communications from the KVM/Ethernet modules over the local network may include receiving the Ethernet communications from the KVM/Ethernet modules over the subnetwork, as indicated at block 216; and/or providing the Ethernet communications corresponding to the IP packets to the KVM/Ethernet modules over the local network may include providing the Ethernet communications to the KVM/Ethernet modules over the subnetwork, as indicated at block 220.

As indicated at block 208, the method may include receiving over the local network Ethernet communications from one or more other KVM/Ethernet modules, which are connected by another local network. The method may also include routing IP packets corresponding to the Ethernet communications from the other KVM/Ethernet modules to the remote consoles over the communication link, as described above with reference to block 212. For example, router 132 (FIG. 1) may receive via local network 199 of switch 114 (FIG. 1) IP packets from KVM switch 154 (FIG. 1); and route over network 150 (FIG. 1) the IP packets received from KVM switch 154 (FIG. 1), e.g., as described above.

As indicated at block 222, the method may include switching to the one or more servers KVM data, e.g., keyboard-mouse data, corresponding to the IP packets received from the remote consoles. For example, KVM switching matrix 122 (FIG. 1) may switch KVM data received from KVM/IP modules 124 and 126 (FIG. 1) to servers 102 (FIG. 1), 104 (FIG. 1) and/or 106 (FIG. 1), e.g., as described above.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of embodiments of the invention have been illustrated and described herein, many modifications, substitutions, changes, and equivalents may occur to those skilled in the art. It is, therefore, to be understood that the appended claims are intended to cover all such modifications and changes.

What is claimed is:

1. A keyboard-video-mouse (KVM) switch comprising:
a plurality of KVM over Ethernet (KVM/Ethernet) modules to communicate KVM data over Ethernet communications; and
a router to route said Ethernet communications between said plurality of KVM/Ethernet modules and one or more remote consoles.

2. The KVM switch of claim 1, wherein said router is to provide said plurality of KVM/Ethernet modules with Ethernet communications including keyboard-mouse data from said remote consoles, and to provide said remote consoles with Internet-Protocol (IP) packets including video data from said plurality of KVM/Ethernet modules.

3. The KVM switch of claim 1, wherein said plurality of KVM/Ethernet modules are to provide to said router Ethernet communications including video data based on a plurality of video inputs, respectively; and wherein said plurality of KVM/Ethernet modules are to generate a plurality of respective keyboard-mouse outputs based on Ethernet communications including keyboard-mouse data.

4. The KVM switch of claim 1, wherein said plurality of KVM/Ethernet modules are assigned with a plurality of addresses, respectively, to communicate with said router via a local network, and wherein said router is capable of communicating with said remote consoles using an address different from said plurality of addresses.

5. The KVM switch of claim 4, wherein said router is capable of communicating with said remote consoles using an Internet Protocol (IP) address.

6. The KVM switch of claim 4 comprising a local network switch to communicate between said plurality of KVM/Ethernet modules and said router via said local network.

7. The KVM switch of claim 4 comprising a port to connect said local network to a local network of at least one other KVM switch.

8. The KVM switch of claim 1 comprising:
one or more server ports to be connected to one or more servers, respectively; and
a KVM switching matrix to switch KVM data between said servers and said plurality of KVM/Ethernet modules.

9. The KVM switch of claim 7 comprising at least one port to be connected to at least one local console, wherein said KVM switching matrix is to switch KVM data between said servers and said at least one local console.

10. The KVM switch of claim 7 comprising a processor capable of controlling switching of said KVM data by said KVM switching matrix, wherein said processor includes said router.

11. The KVM switch of claim 1, wherein said KVM/Ethernet modules comprise KVM over Internet protocol (KVM/IP) modules, and wherein said Ethernet communications comprise IP packets.

12. The KVM switch of claim 1 comprising an integrated circuit including said router and said plurality of KVM/Ethernet modules.

13. A system to communicate keyboard-video-mouse (KVM) information, the system comprising:
one or more servers; and
at least one KVM switch to switch KVM data between said one or more servers and one or more remote consoles, the KVM switch comprising:
a plurality of KVM over Ethernet (KVM/Ethernet) modules to communicate KVM data corresponding to said servers over Ethernet communications; and
a router to route said Ethernet communications between said plurality of KVM/Ethernet modules and said remote consoles.

14. The system of claim 13, wherein said router is to provide said plurality of KVM/Ethernet modules with Ethernet communications including keyboard-mouse data from said remote consoles, and to provide said remote consoles with Internet-Protocol (IP) packets including video data from said plurality of KVM/Ethernet modules.

15. The system of claim 13, wherein said plurality of KVM/Ethernet modules are to provide to said router Ethernet communications including video data based on a plurality of video inputs, respectively; and wherein said plurality of KVM/Ethernet modules are to generate a plurality of respective keyboard-mouse outputs based on Ethernet communications including keyboard-mouse data.

16. The system of claim 13, wherein said plurality of KVM/Ethernet modules are assigned with a plurality of addresses, respectively, to communicate with said router via a local network, and wherein said router is capable of communicating with said remote consoles using an address different from said plurality of addresses.

17. The system of claim 16, wherein said KVM switch comprises a port to connect said local network to a local network of at least one other KVM switch.

18. The system of claim 13, wherein said KVM switch comprises:
one or more server ports to be connected to one or more servers, respectively; and
a KVM switching matrix to switch KVM data between said servers and said plurality of KVM/Ethernet modules.

19. The system of claim 18, wherein said KVM switch comprises a processor capable of controlling switching of said KVM data by said KVM switching matrix, and wherein said processor includes said router.

20. The system of claim 13, wherein said KVM/Ethernet modules comprise KVM over Internet protocol (KVM/IP) modules, and wherein said Ethernet communications comprise IP packets.

21. The system of claim 1, wherein said KVM switch comprises an integrated circuit including said router and said plurality of KVM/Ethernet modules.

22. A method of communicating keyboard-video-mouse (KVM) information, the method comprising:
receiving over a local network Ethernet communications from a plurality of KVM over Ethernet (KVM/Ethernet) modules, wherein said Ethernet communications comprise KVM data to be provided to one or more remote consoles; and
routing Internet Protocol (IP) packets corresponding to said Ethernet communications from said plurality of KVM/Ethernet modules to said remote consoles over a communication link.

23. The method of claim 22 comprising:
receiving from said remote consoles IP packets including KVM data; and
providing Ethernet communications corresponding to the IP packets received from said remote consoles to said plurality of KVM/Ethernet modules over said local network.

24. The method of claim 22, wherein said plurality of KVM/Ethernet modules are assigned with a plurality of respective addresses, and wherein said routing comprises using an address different from said plurality of addresses.

25. The method of claim 22 comprising:
receiving over said local network Ethernet communications from one or more other KVM/Ethernet modules, which are connected by another local network; and
routing IP packets corresponding to the Ethernet communications from said other KVM/Ethernet modules to said remote consoles over said communication link.

26. The method of claim 22 comprising:
switching KVM data received from one or more servers to said plurality of KVM/Ethernet modules; and
switching KVM data corresponding to IP packets received from said remote consoles from said plurality of KVM/Ethernet modules to said servers.

27. The method of claim 26 comprising switching KVM data between said servers and at least one local console.

28. The method of claim 22, wherein said KVM/Ethernet modules comprise KVM over IP (KVM/IP) modules, and wherein said Ethernet communications comprise IP packets.
